(19) United States
(12) Patent Application Publication
(10) Pub. No.: US 2010/0079653 A1
(43) Pub. Date: Apr. 1, 2010

(54) PORTABLE COMPUTING SYSTEM WITH A SECONDARY IMAGE OUTPUT

(75) Inventor: Aleksandar Pance, Saratoga, CA (US)

Correspondence Address: DORSEY & WHITNEY LLP;on behalf of APPLE, INC., 370 SEVENTEENTH ST., SUITE 4700, DENVER, CO, 80202-5647, US

(73) Assignee: Apple Inc., Cupertino, CA (US)

(21) Appl. No.: 12/238,564

(22) Filed: Sep. 26, 2008

(51) Int. Cl. H04N 5/222

(52) U.S. Cl. 348/333.1; 348/E05.022

(57) ABSTRACT

A system for image projection. The image projection system may include a portable computing system, which includes at least a secondary image output and a camera. The image projection system may correct images projected by the secondary image output for image distortion using images captured by the camera and measurements provided by sensors.

### CROSS-REFERENCE TO RELATED APPLICATIONS

This application is related to copending patent application Ser. Nos. (Attorney Docket No. 190197/US), entitled “Method and Apparatus for Depth Sensing Keystoning” and Ser. No. (Attorney Docket No. 190196/US), entitled “Projection Systems and methods,” and filed on Sep. 8, 2008, the entire disclosures of which are incorporated herein by reference.

### FIELD OF THE INVENTION

The present invention generally relates to image projection systems and, more specifically, to an image processing system integrated into a portable computing system.

### BACKGROUND

Various people, including business professionals, students, families and so on may present visual and/or video presentations to one or multiple people. The presentations may take place in a number of settings, such as meetings, conferences, educational settings, social settings and so forth. The presentation may also take various forms, including video or audiovisual presentations. Often, the presentation may require a projection system so that the slides, pictures, video and so on may be displayed on a surface so that the projected images may be viewed by at least the intended audience.

A common issue for presenters is the absence of a projection system and/or video system that projects the images onto a surface so that one or multiple people may view the images without gathering around a laptop screen. For example, when presenting a slide show of vacation pictures, the presenter often has the pictures stored on a laptop. The presenter may wish to share the vacation pictures with others and this may require the viewers to gather around the laptop screen to view the pictures. Although an external projector may be connected to the laptop, an integrated system may advantageously affect factors including, size of the system, power, usability, image processing capabilities and so forth. Thus, an integrated system and method for image projection may be useful.

### SUMMARY

One embodiment of the present invention takes the form of an image projection system. The image projection system may include at least one data capture device. The data capture device may be configured to transmit captured data to an image processing system configured to receive the captured data. The image projection system may also include a primary image output device and a secondary image output device, where each device may be configured to receive image data from the image processing system. The image projection system may also include an enclosure surrounding at least the data capture device, the primary image output device and the secondary image output device. The secondary image output device may be a projection system.

Additionally, the image projection system may also include at least two depth sensors configured to transmit measurements to the image processing system. Further, the data capture device may be a camera that may be separately adjustable from the enclosure and the secondary image output device may also be separately adjustable from the enclosure.

Another embodiment may take the form of a portable computing system. The portable computing system may include an enclosure, a primary image output physically integrated with the enclosure and a secondary image output physically integrated with the enclosure. The secondary image output may be configured to project an image. The portable computing system may also include at least one data capture device integrated with the portable computing system and which may be configured to capture at least image data and further, may be a camera. The secondary image output and the camera may each be separately adjustable from the enclosure and separately adjustable from one another.

Yet another embodiment may take the form of a portable computer, which may include a body, an image output device configured to project an image and a screen pivotally coupled to the body, where the screen may include a data capture device. The portable computer may include at least two depth sensors which may be configured to transmit measurements to an image processing system in the portable computer.

These and other advantages and features of the present invention will become apparent to those of ordinary skill in the art upon reading this disclosure in its entirety.

### BRIEF DESCRIPTION OF THE DRAWINGS

FIG. 1A shows a portable computing system with an integrated image processing system including an image projection system with sensors.

FIG. 1B shows another portable computing system with an integrated image processing system.

FIG. 2 shows an example of a portable computing system with an integrated image processing system projecting an image on a projection surface.

FIG. 3 is a flowchart depicting operations of another embodiment of an image processing method employing image correction.

### DETAILED DESCRIPTION OF EMBODIMENTS

Generally, one embodiment of the present invention may take the form of an image processing system, such as a portable computing system, including at least a primary image output, a secondary image output, at least one camera and at least two sensors. The secondary image output may project an image that may be stored in a main or a temporary memory of the portable computing system. The camera may capture the projected image, which may be used by the portable computing system to correct image distortion in the projected image. The portable computing system may perform such image processing on a video processor, central processing unit, graphical processing unit and so on. Additionally, the portable computing system may obtain and use data such as depth measurements to correct for image distortion or for movement of the portable computing system after calibration of the portable computing system or its secondary image output. The depth measurements may be supplied by depth sensors located, for example, adjacent to or nearby the secondary image output. Further, additional depth sensors may be included on the portable computing system in other locations such as on the bottom of the portable computing system. The additional depth sensors may supply depth measurements that may be used to correct for any pitch and roll of the portable computing system. Other types of sensors such as accelerometers may also be used to correct for pitch, yaw, tile, roll and so on. Ambient light sensors may also be used to correct for ambient light compensation.

Another embodiment may take the form of a method for integrating into one system the ability to project an image and correct the image for image distortion. In this embodiment, the image may be projected by a secondary image output located in a portable computing system. The portable computing system may be oriented at a non-orthogonal angle to the projection surface and the projected image may be distorted. In this embodiment, a data capture device, such as a camera, may be located in the portable computing system and may be used to capture an image of the projected image. The captured image may be used for image processing, such as to correct any distortion in the projected image.

It should be noted that embodiments of the present invention may be used in a variety of optical systems, computing systems, projection systems and image processing systems. The embodiment may include or work with a variety of computer systems, processors, servers, remote devices, self-contained projector systems, visual and/or audiovisual systems, optical components, images, sensors, cameras and electrical devices. Aspects of the present invention may be used with practically any apparatus related to optical and electrical devices, optical systems including systems that may affect properties of visible light, presentation systems or any apparatus that may contain any type of optical system. Accordingly, embodiments of the present invention may be used in or with a number of computing environments including the Internet, intranets, local area networks, wide area networks and so on.

Before proceeding to the disclosed embodiments in detail, it should be understood that the invention is not limited in its application or creation to the details of the particular arrangements shown, because the invention is capable of other embodiments. Moreover, aspects of the invention may be set forth in different combinations and arrangements to define inventions unique in their own right. Also, the terminology used herein is for the purpose of description and not of limitation.

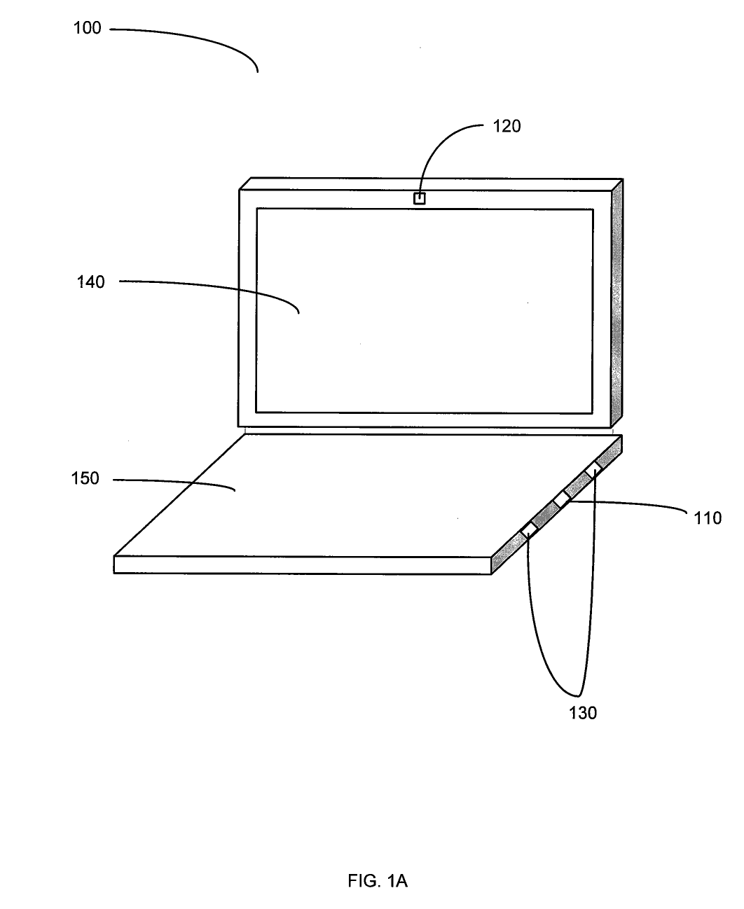

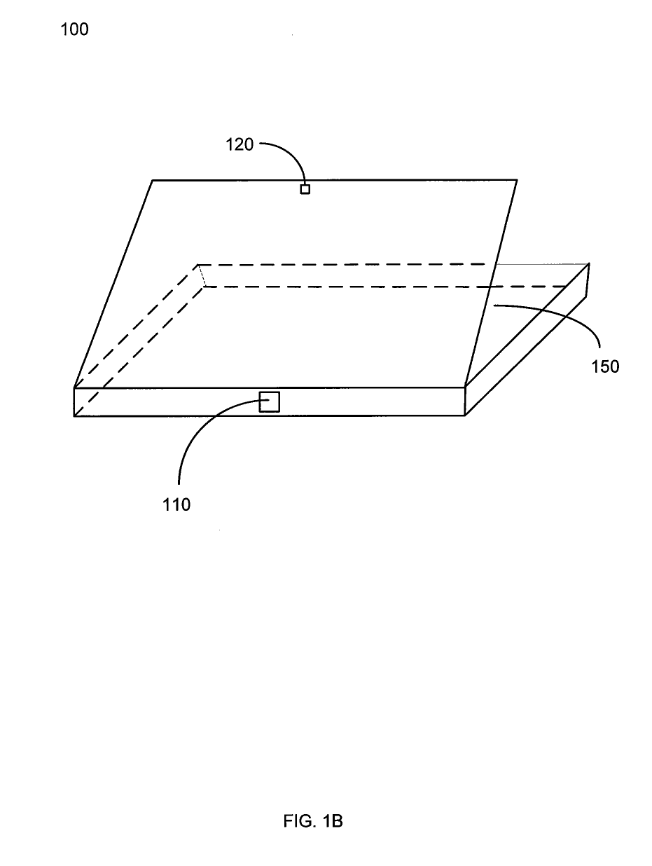

FIG. 1A depicts one embodiment of a portable computing system 100. The portable computing system 100 may be, for example, a laptop computer with an integrated image processing system. The portable computing system 100 of FIG. 1A includes a primary image output 140, a secondary image output 110, a camera 120 and multiple sensors 130. The primary image output 140 may be an integrated or attached display device, such as a built-in liquid crystal display (“LCD”) screen 140 or attached monitor and thus ay encompass an integrated display. Regardless, the portable computing system typically includes a primary display output in addition to the secondary image output. Furthermore, the secondary image output 110 may be a device such as a projection system. Additionally, the portable computing system 100 may include an image processor (not shown in FIG. 1A) which may be any type of processor, such as a central processing unit, a graphical processing unit and so on. The image processor may also execute at least portions of a software system or package (also not shown in FIG. 1A) and may directly or operationally connect to the secondary image output.

In FIG. 1A, the secondary image output 110 is located on the side of the portable computing system body 150. The secondary image output 110 may be located in various positions on the portable computing system 100. For example, as depicted in FIG. 1B, the secondary image output 110 may be located on the back of the portable computing system 100. This configuration will be discussed in more detail below. The positioning of the secondary image output 110 on the portable computing system 100 may depend on a number of factors such as size of the secondary image output 110 and/or the size of the portable computing system 100, the type of light source employed by the secondary image output 110, the cooling system of the portable computing system 100 and so on.

The secondary image output may connect to or receive data from the graphical processing unit, the central processing unit and/or the software system via a digital video interface (“DVI”) port. The DVI port may connect the portable computing system to the secondary image output when the secondary image output is configured to be recognized by the portable computing system as a digital display device. The DVI port may communicate a digital video signal from the central processing unit or graphical processing unit to the secondary image output. Additionally, other analog interfaces, such as a video graphics array connector, may also be employed for connecting to or receiving data from the graphical processing unit, the central processing unit, and/or the software system.

Although other types of interfaces may be used, the DVI does not need to employ a digital-to-analog conversion that may cause the signal to degrade and accordingly, degrade the image as shown via the secondary image output. Various interfaces may be used, such as transition minimized differential signaling (“TMDS”) which may be used for high speed transmission of serial data, high definition multimedia interface (“HDMI”) which may be used for the transmission of uncompressed digital streams, red green blue ports, display ports (“DP”) and so on. It may be possible to toggle between the interfaces on the portable computing system.

In another embodiment, the graphical processing unit may be part of the secondary image output system and may perform image processing tasks instead of receiving data via an interface from the graphical processing unit located in the portable computing system. In this embodiment, the secondary image output may be located in the portable computing system. The secondary image output may perform image processing tasks using a graphical processing unit located within the secondary image output system. Alternatively, in another embodiment, the graphical processing unit may be located outside of the secondary image output system, but still within the portable computing system. The graphical processing unit may perform the image processing tasks and then transmit the image data to the secondary image output for projection.

In FIGS. 1A and 1B, the physical size of the secondary image output 110 may depend on the light source employed to project the image. For example, the secondary image output 110 may be a projection system that may use a light source such as a light emitting diode (“LED”), a laser diode-based light source and so on. In another example, if the light source employed by the secondary image output 110 is a white light source, the size of the secondary image output may be much larger than if the light source is a semiconductor light source.

The type of light source employed by the secondary image output 110 may depend on the intended environment of the portable computing system 100. For example, if the portable computing system 100 is for use in a conference room setting, then the amount of light output by the secondary image output 110 may be less than if the portable computing system 100 is intended for use in an auditorium presentation. Additionally, variations in ambient lighting conditions may affect the type of light source that is used in the portable computing system 100. For example, if the portable computing system 100 is intended for use in an environment with varying ambient lighting conditions, such as natural light from windows in the room, fluorescent lighting and so on, the light source employed by the secondary image output 100 may need to be adjustable. For example, the light source may be brightened to account for the ambient lighting conditions during the day and dimmed to account for the evening lighting conditions.

The physical size of the secondary image output 110 may also depend on the size of the portable computing system 100. The configuration of the portable computing system components may allow for varying sizes of the secondary image output 110. Further, the configurations of both the portable computing system components and the secondary image output 110 may be arranged to allow for sufficient cooling and operability of the systems. For example, the distance between the mother board of the portable computing system and the secondary image output 110 may be maximized to ensure sufficient cooling of the portable computing system in its entirety. In turn, the size of the portable computing system 100 may depend on a number of factors including, but not limited to, the speed of the central processing unit in the portable computing system 100, the size of the screen 140 of the portable computing system 100, the hard drive capacity of the portable computing system 100 and so on. For example, the size of the screen 140 of the portable computing system 100 may be seventeen inches instead of fifteen inches. In this case, the amount of space that the secondary image output 110 may occupy in the portable computing system body 150 may be greater. (The screen sizes used herein are for explanatory purposes only.) As another example, the amount of space the hard drive occupies in the portable computing system body 150 may increase as the hard drive capacity increases. Continuing the example, less space may be available for the secondary image output 110 in the portable computing system body 150 as the hard drive capacity increases in the system, presuming the exterior size of the body remain constant.

In FIGS. 1A and 1B, the location of the secondary image output 110 within the portable computing system 100 may also depend on the cooling system of the portable computing system 100. Many portable computing systems employ cooling systems. The cooling system may function to cool multiple elements such as printed circuit boards, memory drives, optical drives and so on. The secondary image output 100 may use the same cooling system as the portable computing system 100 or may use a separate cooling system. Depending on the light source and the heat output of the light source, one or more additional cooling systems may be employed in the portable computing system 100. Additionally, the type of cooling system and whether one or more additional cooling systems are included in the portable computing system 100 may depend on the available physical space in the portable computing system 100

The secondary image output 110 of the portable computing system 100 may project an image onto a surface. The secondary image output 110 may be a projection system that is integrated into the portable computing system 100. The secondary image output 110 may project an image away from the portable computing system 100 so that one or multiple viewers may view the projected image. The secondary image output 110 may project the image onto a screen, a wall or any other type of surface that may allow the projected image to be viewed by multiple viewers. The image that may be projected from the secondary image output 110 may be generated from any type of file on the portable computing system 100. For example, the projected image may be a slideshow, an image shown on the computer display 140 itself, static video, or may be any other type of visual presentation. The flow of the image information between the portable computing system 100 and the secondary image output 110 and the camera 120 will be discussed in further detail below.

The projection surface used by the secondary image output 110 may be curved and/or textured. In such cases, the secondary image output 110 may compensate for the surface's irregularities. Further, the secondary image output may compensate for the projection surface being at an angle, in addition to various other surface irregularities on the projection screen such as multiple bumps or projecting an image into a corner. Further, in this embodiment, the projection surface may be any type of surface such as a wall, a whiteboard, a door and so on, and need not be free of surface planar irregularities. The projection surface may be oriented at any angle with respect to the image projection path and may include sharp corners or edges, such as a corner of a room, a curved surface, a discontinuous surface and so on. The image correction methodologies will be discussed in more detail below with respect to the camera discussion and are also discussed in Attorney Docket No. P6033US1 (190197/US), titled “Method and Apparatus for Depth Sensing Keystoning” and Attorney Docket No. P6034US1 (190196/US), titled “Projection Systems and Methods”, which are incorporated herein in its entirety by reference.

The secondary image output 110 may also be adjustable and/or may rotate with respect to the portable computing system 100. For example, the secondary image output 110 may be a projection system 110 located on the side of the portable computing system 100. Continuing the example, when the secondary image output 110 is located on the side of the portable computing system 100 as depicted in FIG. 1A, the operator of the portable computing system 100 may be able to use the keyboard of the portable computing system 100 while projecting the images at the same time. More specifically, by locating the secondary image output 110 on the side of the portable computing system 100, the user may orient the portable computing system 100 such that the portable computing system display is approximately orthogonal to the projection surface.

The secondary image output 110 may appear as an additional display to a processor of the portable computing system 100. For example, the portable computing system 100 may be configured to display images via at least two display devices, such as the primary image output 140 and the secondary image output 110. The portable computing system 100 may be configured via hardware or software to use at least two screens. In another example, the operating system may allow the user to access a monitor menu and choose the screens for displaying images, where one of the “screens” is the secondary image output 110. In yet another example, the portable computing system 100 may be configured to allow the user to toggle through different outputs, including the secondary image output 110.

Still with respect to FIG. 1A, as mentioned previously, the secondary image output 110 may be a projector system. The projector system may use an LED or a laser-diode based light source. The amount of power employed by the projector may require less power than a stand alone projector system with a white light source. The lower power requirement of the projector may be due to the type of light source employed by the projector. The light source that may be used in the projector system may be selected based at least partially on the environment in which the portable computing system 100 may be used.

As depicted in FIG. 1A, a data capture device 120, such as a camera, may be located above the screen of the portable computing system 100. The location of the camera in the portable computing system 100 and the number of cameras that may be employed will be discussed in further detail below. The camera 120 may be used for capturing images that may be used for image correction, video chatting and so on. The camera 120 may be in communication with the image processing system and/or the central processing unit of the portable computing system 100 and the captured images may be transferred to the processing systems for analysis. Further, the images captured by the camera 120 may be transferred as video data information to the graphical processing unit of the portable computing system 100. The video data information may be used by the processing systems to generate the transforms that may be employed for keystoning correction as discussed in Attorney Docket No. P6033 (190197/US), titled “Method and Apparatus for Depth Sensing Keystoning,” and filed on Sep. 8, 2008. The processing systems may include the graphical processing unit and/or the central processing unit of the portable computing system 100. Depending on the data processing to be performed, the graphical processing unit and/or the central processing unit may be employed for the image processing.

The camera 120 of the portable computing system may be centrally located above the front side of the portable computing system screen 140. In addition to locating the camera above the screen, the camera may be located in various places including any place on the front side of the screen casing, on the back side of the screen casing of the portable computing system 100 and so on. Furthermore, the camera 120 may serve multiple functions for the portable computing system 100 such as video chatting, image capture and other applications. The location of the camera 120 may depend on various factors, including but not limited to, the location of the secondary image output 110. For example, if the secondary image output 110 is located on the back of the portable computing system body 150, the camera may be located on the back of the casing of the portable computing system screen 140 as depicted in FIG. 1B.

More than one camera may be incorporated into the portable computing system 100. The number of cameras may depend on various factors such as the location of the secondary image output 110, whether the cameras are adjustable, the various functions of the cameras and so on. As one example, a portable computing system 100 may include two cameras, one on the front of the screen casing and one located on the back of the screen casing. The camera on the front of the screen casing may be used for video chatting, video conferencing, photo applications and other applications, while the camera on the back of the screen may be a dedicated camera used only for image processing such as capturing images to correct for distortion. In one example, either of the cameras may be used for capturing images that may be used for image correction and a user may choose which camera to employ for capturing images. In another example, one camera may be used for applications such as video chatting while the other camera may be a camera dedicated specifically for capturing images used for image processing purposes. Continuing this example, the camera dedicated to image processing purposes may be located on the back of the portable computing system screen while the camera used for other applications may be located on the front of the screen. Additionally, in this example, the secondary image output may be located on the back of the portable computing system screen.

The portable computing system 100 may have one or more cameras that may be adjustable so that the image projected by the secondary image output 110 may be placed within the field of view of the camera 120. For example, the secondary image output 110 may be located on the side of the portable computing system and the camera 120 may be located on the front side of the screen casing. The angle of the camera may be adjusted so that the image projected by the secondary image output may fall within the field of view of the camera. In this example, the camera may be positioned inside an aperture, such that the camera may be adjusted without limiting the line of sight and/or field of view of the camera. Further, this may be achieved in various ways such as, but not limited to, adjusting the size of the aperture with respect to the camera, by aligning the camera lens with the surface of display casing in which the camera is located and so on.

Additionally, the image may also be brought into the field of view of the camera by adjusting the projection angle of the secondary image output or by orienting the portable computing system (by angling the computer for example) so that the image is within the field of view of the camera. For example, the portable computing system may be placed at a distance such that the field of view of the camera increases enough to capture the image projected by the secondary image output.

As depicted in FIG. 1B, the secondary image output 110 and a camera may be located on the back of the portable computing system 100. The camera may be located on the back of the portable computing system to ensure that the image projected by the secondary image output may be within the field of view of the camera.

The camera 120 may capture an image that is projected by the secondary image output 110. The image may be transferred from the camera to a processor such as the image processor, the central processing unit and so on. The image may be used to correct for any distortion of the image projected by the secondary image output. Image distortion may result from various factors, such as the portable computing system and the projection surface being oriented at a non-orthogonal angle to one another. As another example, an image may be projected onto a projection surface that may not be substantially flat. As yet another example, the image projection system may be placed at a non-right angle with respect to the projection surface. (That is, the image projection system may not be placed substantially orthogonal to each of a vertical and horizontal centerline of the projection surface.) In this example, the projected image may appear distorted because the length of the projection path of the projected image may differ between the projection surface and the image projection system. The lengths of the projection path may vary in different parts of the projected image because the projection surface may be closer to the image projection system in some places and further away in other places. The projection path may be the path of the image between the projection system and the projection surface and even though described as “a projection path,” may be separated into multiple lengths, where each length may be between the projection system and the projection surface. Thus, the lengths of the projection path may vary in a projection path.

Image distortion may result because the magnification of the projected image (or ports thereof) may change with increasing or decreasing distance from the optical axis of the image projection system. The optical axis may be the path of light propagation between the image projection system and the projection screen or surface. Accordingly, if the left side of the projection screen is closer to the image projection system, the projection path may be shorter for the left side of the projection screen. The result may be that a projected line may appear shorter on the left side of the projection screen then a projected line on the right side of the projection screen, although both lines may be of equal length in the original image.

The camera may be able to capture black and white images or color images. The method used for mapping and correcting image distortion in color images is similar to the method used for black and white images as discussed in Attorney Docket No. P6033 (190197/US), titled “Method and Apparatus for Depth Sensing Keystoning.” Additionally, the camera may be able to capture dynamic images such as video to provide continuous image processing feedback for image correction. The image correction may include keystoning, color correction, intensity of light correction for the ambient light in the environment and so on. The portable computing system 100 may perform real time, per-pixel and per-color (RGB) image processing and image correction including (horizontal/vertical) correction, compensation for surface curvature and surface texture. Further, an ambient light sensor may be employed for ambient light compensation.

The keystoning correction may be achieved by including one or multiple sensors 130, such as depth sensors on the portable computing system 100 of FIG. 1A. Additionally, various sensors such as accelerometers, ambient light sensors and so on, may also be included in the portable computing system 100 of FIG. 1A. Generally, sensors that may be employed in the portable computing system 100 of FIG. 1A, may be internally located in the portable computing system 100 or externally located on the portable computing system. The depth sensors 130 may be located adjacent to the secondary image output 110. The functionality of the depth sensors is discussed in detail in Attorney Docket No. P6033 (190197/US), titled “Method and Apparatus for Depth Sensing Keystoning.” Furthermore, the camera 120 may include pixels where each of the pixels may be a depth sensor. The depth sensors may be used for keystoning correction. Moreover, the discussion herein relating to keystoning correction, image distortion and image processing is discussed in detail in Attorney Docket No. P6033 (190197/US), titled “Method and Apparatus for Depth Sensing Keystoning.”

Furthermore, the depth sensors may be used for various functions including calibrating an image processing system, correcting for image distortion, correcting for the pitch, yaw and roll of a system and so on. The depth sensors may be located on the portable computing system in various locations such as adjacent to the secondary image output, on the bottom of the portable computing system, on the horizontal sides of the portable computing system and so on. The depth sensors may be used for different functions depending on where the depth sensors are located on the portable computing system. For example, the depth sensors located adjacent to the secondary image output may be used for correcting image distortion while depth sensors located on the bottom of the portable computing system may be used to correct for the pitch or roll of the portable computing system.

The depth sensors 130 may also be used to compensate for movement of the portable computing system 100 after the image has been projected and corrected for image distortion. For example, the projected image may have been previously corrected for distortion using keystoning, but the portable computing system may be moved so that the angle of the portable computing system may be changed with respect to the projection surface. The image processing system may correct for the movement of the portable computing system without re-calibrating the system using the depth sensors located adjacent to the secondary image output. In this embodiment, additional depth sensors may be used to correct for pitch, roll and yaw. The additional depth sensors may be located on the portable computing system 100 in locations other than adjacent to the secondary image output such as the bottom of the portable computing system or on all the horizontal sides of the portable computing system. The additional depth sensors may allow for collection of data from which the position of the portable computing system 100 may be determined. An image processor may then employ the data to estimate the image distortion that results from moving the portable computing system 100 and the processor may correct the image distortion after the image processing system has been calibrated.

A gyroscope or accelerometer may be employed in conjunction with the secondary image output 110 for image stabilization, to correct for movement of the portable computing system, to correct for tilt, pitch, roll, yaw and so on. The movement of the portable computing system may be caused by movement of the surface that supports the portable computing system, by the operator of the portable computing system 100 typing, or if the screen 140 is bumped (and the camera 170 is located on the screen 140). The gyroscope may be used for image stabilization to prevent the projected image from moving even though the portable computing system may be moving.

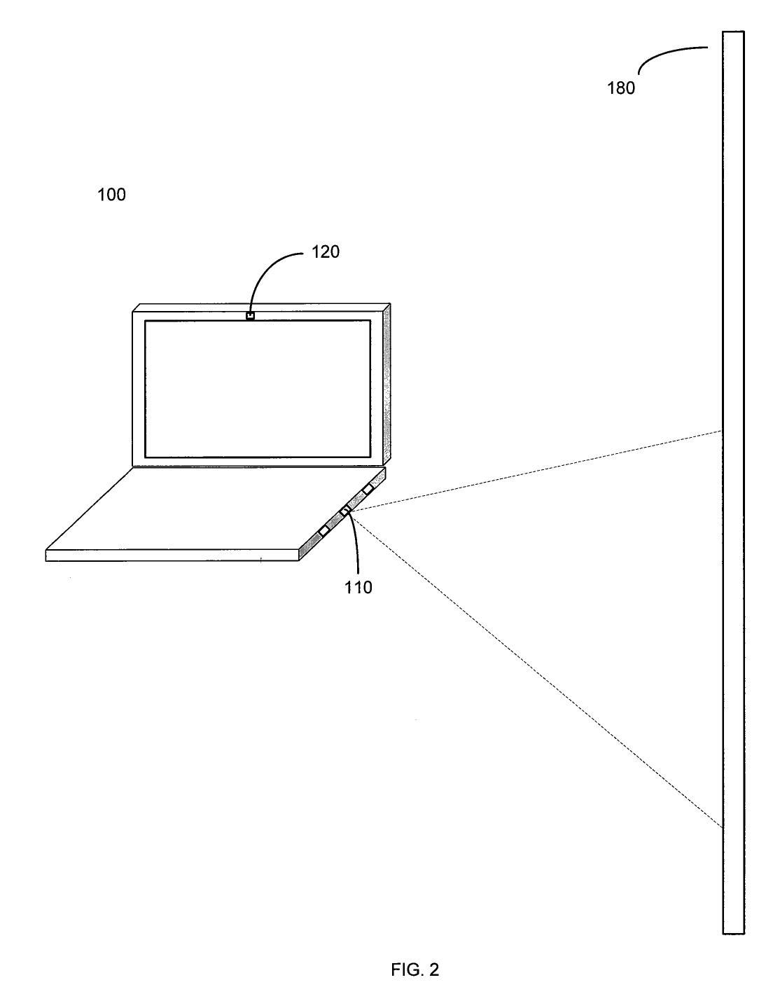

FIG. 2 depicts an example of a portable computing system 100 projecting an image onto a projection surface 180. The portable computing system 100 of FIG. 2 includes a secondary image output 110, a camera 120, multiple sensors 130, a screen 140 and a body 150 of the portable computing system 100. The secondary image output 110 may be a projector system and may be located inside the portable computing system body 150. The portable computing system may be oriented with respect to the projection surface 180 so that the projected image will appear on the projection surface. However, as depicted in FIG. 2, the portable computing system 100 may not be parallel to the projection surface 180, which may produce a distorted image (the distorted image without keystoning correction) on the projection surface 180 as previously discussed with respect to FIG. 1. Even though the portable computing system 100 in FIG. 2 is placed at a non-orthogonal angle to the projection surface 180, the image projected by the secondary image output may appear undistorted to a viewer due to the aforementioned keystoning correction, which may be performed by the portable computing system 100, or any constituent element, such as the secondary image output.

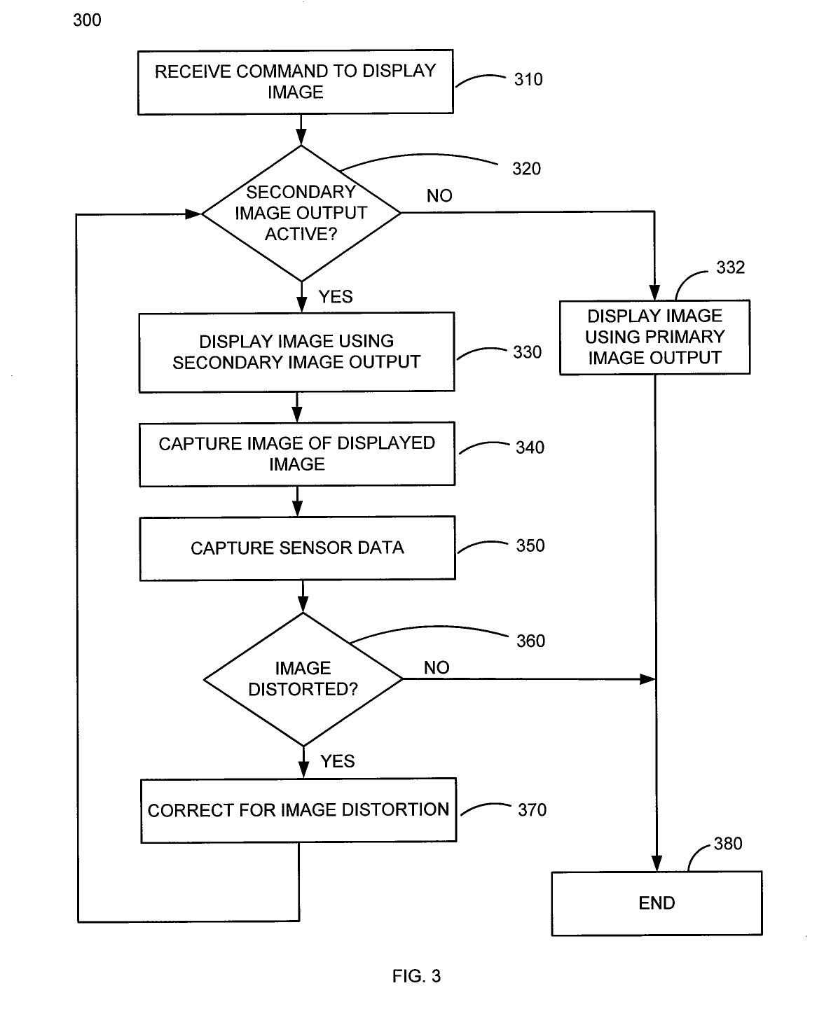

FIG. 3 is a flowchart generally describing operations of an embodiment of an image processing method 300. The image processing method 300 may begin with the operation of block 310, in which a portable computing system may receive a command to display an image. The command may be received by any type of processor and/or image processor employed by the portable computing system such as, but not limited to, a graphical processing unit, a central processing unit and so on. The image for display may be a video, a picture, a slide for a slideshow and so forth. In the decision block 320, the processor may determine whether the secondary image output is active and selected for display purposes. In some embodiments, the secondary image output may, as a default, remain inactive until a user initiates it. Additionally or alternatively, the portable computing system may activate and initialize the secondary image output, after which the secondary image output may enter a low power mode until selected. The determination may be made in the block 320 that the secondary image output is inactive and may not be initiated. In this case, the image may be displayed on the primary image output in the operation of block 332. Alternatively, the determination may be made in the block 320 that the secondary image output is inactive and may be initiated or that the secondary image output is active and that it may display the image.

Once the determination is made by the portable computing system that the secondary image output is active or may become active, in the operation of block 330, the image may be displayed at least by the secondary image output. The image may be displayed by only the secondary image output or by both the primary and secondary image outputs. The projected image may be an image from a picture, a slideshow, a presentation, may be a projection of the computer screen and so on. The secondary image output may be a secondary video output for the portable computing system and may appear to the portable computing system as an additional monitor.

Next, in the operation of block 340, at least one camera associated with, and typically located on or in, the portable computing system may capture the projected image. The captured image may be used by the image processor and/or the software system to calibrate and/or correct any image distortion, lighting intensity issues and so on. As previously discussed, one or cameras may be located in a number of positions on the portable computing system. As an example, the secondary image output may be located on the side of the body of the portable computing system when the camera is located on the front of the screen. In another example, the portable computing system may include two cameras where one may be located on the front of the screen of the portable computing system and another camera may be located on the back of the screen. In this example, the secondary image output may be located on the back of the body of the portable computing system.

In the operation of block 350, the depth sensors may capture and provide data to the portable computing system processor(s). The data captured by the depth sensors may be the distances between the depth sensors (which may be located on the portable computing system) and the projection surface. In the operation of block 360, the determination may be made by the portable computing system whether the projected image is distorted. Sample methodologies employed to make this determination are discussed in Attorney Docket No. P6033 (190197/US), titled “Method and Apparatus for Depth Sensing Keystoning.” The determination may be made that the projected image is not distorted. In this case, the method 300 may proceed to the operation of block 380 and the method 300 may end. The determination may also be made that the projected image is distorted. In this case, the method 300 may proceed to the operation of block 370 described below. The operations of blocks 350 and 360 may be executed in the opposite order. The order described herein for blocks 350 and 360 is provided for explanatory purposes only.

If the embodiment determines that the projected image is distorted, in the operation of block 470 the captured image may be processed by the portable computing system to correct the image for image distortion. The portable computing system may include a video processor, a central processing unit, a graphical processing unit and so on. The portable computing system may use the captured image in addition to other information such as depth measurements, where the depth measurements may be taken using depth sensors located on the portable computing system. The image correction may include correction for static images or for video images. Once the processor of the portable computing system corrects for the image distortion of the projected image, the method 300 may again return to the block 320 and the processors of the portable computing system may determine if the secondary image output is active. Once it is determined whether the secondary image output is active, the corrected image may be displayed on either the secondary image output as in block 330, on the primary image output as in block 332 or on both of the image outputs as encompassed by block 330.

Although the present invention has been described with respect to particular apparatuses, configurations, components, systems and methods of operation, it will be appreciated by those of ordinary skill in the art upon reading this disclosure that certain changes or modifications to the embodiments and/or their operations, as described herein, may be made without departing from the spirit or scope of the invention. Accordingly, the proper scope of the invention is defined by the appended claims. The various embodiments, operations, components and configurations disclosed herein are generally exemplary rather than limiting in scope.

1. An image projection system, comprising:
at least one data capture device configured to transmit captured data to an image processing system configured to receive the captured data;
a primary image output device configured to receive image data from the image processing system;
a secondary image output device configured to receive image data from the image processing system; and
an enclosure surrounding at least the at least one data capture device, the primary image output device and the secondary image output device.

2. The image projection system of claim 1, further comprising at least two depth sensors configured to transmit measurements to the image processing system.

3. The image projection system of claim 1, wherein the secondary image output device is a projection system.

4. The image projection system of claim 1, wherein the primary image output device is a liquid crystal display.

5. The image projection system of claim 2, wherein the image processing system is additionally configured to employ the captured data from the at least one data capture device and the measurements from the at least two depth sensors to correct for image distortion.

6. The image projection system of claim 1, wherein the secondary image output device further comprises a semiconductor light source.

7. The image projection system of claim 1, wherein the at least one data capture device is a camera.

8. The image projection system of claim 1, wherein the secondary image output device is separately adjustable from the enclosure.

9. The image projection system of claim 1, wherein the camera is separately adjustable from the enclosure.

10. A portable computing system, comprising:
an enclosure;
a primary image output physically integrated with the enclosure; and
a secondary image output physically integrated with the enclosure.

11. The portable computing system of claim 10, wherein the secondary image output is configured to project an image.

12. The portable computing system of claim 10, further comprising at least one data capture device integrated with the portable computing system and configured to capture at least image data.

13. The portable computing system of claim 12, wherein the at least one data capture device is a camera.

14. The portable computing system of claim 10, wherein the secondary image output is separately adjustable from the enclosure.

15. The portable computing system of claim 13, wherein the camera is separately adjustable from the enclosure.

16. The portable computing system of claim 10, further comprising at least two depth sensors configured to transmit measurements to an image processing system in the portable computing system.

17. The portable computing system of claim 16, wherein the image processing system is additionally configured to employ the captured data from the at least one data capture device and the measurements from the at least two depth sensors to correct for image distortion.

18. The portable computing system of claim 10, wherein the secondary image output further comprises a semiconductor light source.

19. A portable computer, comprising:
a body;
an image output device configured to project an image; and
a screen pivotally coupled to the body, the screen including a data capture device.

20. The portable computer further comprising at least two depth sensors configured to transmit measurements to an image processing system in the portable computer.
